(19) United States
(12) Patent Application Publication
(10) Pub. No.: US 2025/0389811 A1
(43) Pub. Date: Dec. 25, 2025

(54) ADAPTIVE USER PRESENCE DETECTION USING WIRELESS SIGNALING

(71) Applicant: Dell Products L.P., Round Rock, TX (US)

(72) Inventors: Harpreet Narula, Austin, TX (US); Allen B. McKittrick, Cedar Park, TX (US)

(73) Assignee: Dell Products L.P., Round Rock, TX (US)

(21) Appl. No.: 18/751,619

(22) Filed: Jun. 24, 2024

(51) Int. Cl. G01S 7/00; G01S 13/00; G01S 13/04; G06F 1/3231

(52) U.S. Cl. CPC G01S 7/006; G01S 13/003; G01S 13/04; G06F 1/3231

(57) ABSTRACT

Embodiments provide adaptive user presence detection by a first Information Handling System (IHS). The first IHS transmits and receives wireless communications with a second IHS using a wireless network controller of the first IHS. A context is determined in which the first IHS transmits and receives the wireless communications with the second IHS. Based on the context of the wireless communications, a wireless signaling profile is selected for use by the wireless network controller in the wireless communications with the second IHS, where the selected wireless signaling profile adapts the transmission and reception of the wireless communications with the second IHS in supporting different types of user presence detection by the first IHS. Use the wireless communications that have been adapted according to the wireless signaling profile to locate a user of the first IHS relative to the first IHS.

### FIELD

This disclosure relates generally to Information Handling Systems (IHSs), and more specifically, to user presence detection by IHSs.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Variations in IHSs allow for IHSs to be general or configured for a specific user or specific use, such as financial transaction processing, airline reservations, enterprise data storage, or global communications. In addition, IHSs may include a variety of hardware and software components that may be configured to process, store, and communicate information and may include one or more computer systems, data storage systems, and networking systems.

IHSs may support a variety of technologies that may be used in determining the location of the user relative to the IHS, thus supporting the ability to identify scenarios such as when a user of the IHS is no longer in close proximity to the IHS, or when multiple individuals in are in close proximity to the IHS. Complex user presence detection capabilities typically utilize telemetry data collected from multiple sensors of an IHS, such as utilizing data collected by time-of-flight sensors and images captured by cameras. However, in many scenarios, such sensors and/or processing resources required to implement complex user detection capabilities are not available in some IHSs and/or are not always available.

### SUMMARY

In various embodiments, systems and methods provide adaptive user presence detection by a first Information Handling System (IHS). Embodiments may include: transmitting and receiving wireless communications with a second IHS using a wireless network controller of the first IHS; determining a context in which the IHS transmits and receives the wireless communications with the second IHS; based on the context of the wireless communications, selecting a wireless signaling profile for use by the wireless network controller in the wireless communications with the second IHS, wherein the selected wireless signaling profile adapts the transmission and reception of the wireless communications with the second IHS in supporting different types of user presence detection by the IHS; and using the wireless communications that have been adapted according to the wireless signaling profile to locate a user of the IHS relative to the IHS.

In some embodiments, the IHS comprises at least two antennas for the transmission and reception of the wireless communications, and wherein the selected wireless signaling profile adapts the transmission and reception by the antennas in order to support a specific type of user presence detection. In some embodiments, the specific type of user presence detection comprises detecting whether the user is located within a proximity to the IHS. In some embodiments, the context in which the IHS transmits and receives the wireless communications with the second IHS comprises a low power mode of the IHS. Some embodiments may include waking the IHS from the low power mode in response to locating the user of the IHS within the proximity to the IHS using the wireless signaling profile. In some embodiments, the specific type of user presence detection comprises detecting gestures made by the user. In some embodiments, the context in which the IHS transmits and receives the wireless communications with the second IHS comprises an application of the IHS operating in a presentation mode. Some embodiments may include conducting an operation of the presentation mode in response to detecting a gesture made by the user through use of the wireless signaling profile. In some embodiments, the specific type of user presence detection comprises detecting whether the user's hands are located in proximity to the IHS. In some embodiments, the context in which the IHS transmits and receives the wireless communications with the second IHS comprises a level of ambient light detected by the IHS. Some embodiments may include illuminating lighting of the IHS in response to detecting the user's hands in proximity to the IHS. In some embodiments, the wireless network controller of the first IHS uses the selected wireless signaling profile to adapt the transmission and reception of the wireless communications with the second IHS in supporting different types of user presence detection by the IHS. In some embodiments, the selected wireless signaling profile adapts the transmission and reception of the wireless communications with the second IHS by utilizing directional wireless signaling information provided by the second IHS. In some embodiments, the selected wireless signaling profile adapts the transmission and reception of the wireless communications with the second IHS by modifying directional wireless signaling information generated by the two or antennas in the transmission and reception of wireless communications with the second IHS. In some embodiments, the selected wireless signaling profile adapts the transmission and reception by the two or more antennas in order to support a specific type of user presence detection by modifying sensitivity settings used by the antennas in the reception of wireless communications from the second IHS.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a diagram illustrating examples of components of an Information Handling System (IHS) configured, according to some embodiments, to support adaptive user presence detection by the IHS through adaptive configuration of wireless signaling by the IHS.

FIG. 2 is a diagram illustrating additional examples of components of an Information Handling System (IHS) configured, according to some embodiments, to support adaptive user presence detection by the IHS through adaptive configuration of wireless signaling by the IHS.

FIG. 3 is a flowchart illustrating an example of a method, according to some embodiments, for adaptive user presence detection by an IHS through adaptive configuration of wireless signaling by the IHS.

### DETAILED DESCRIPTION

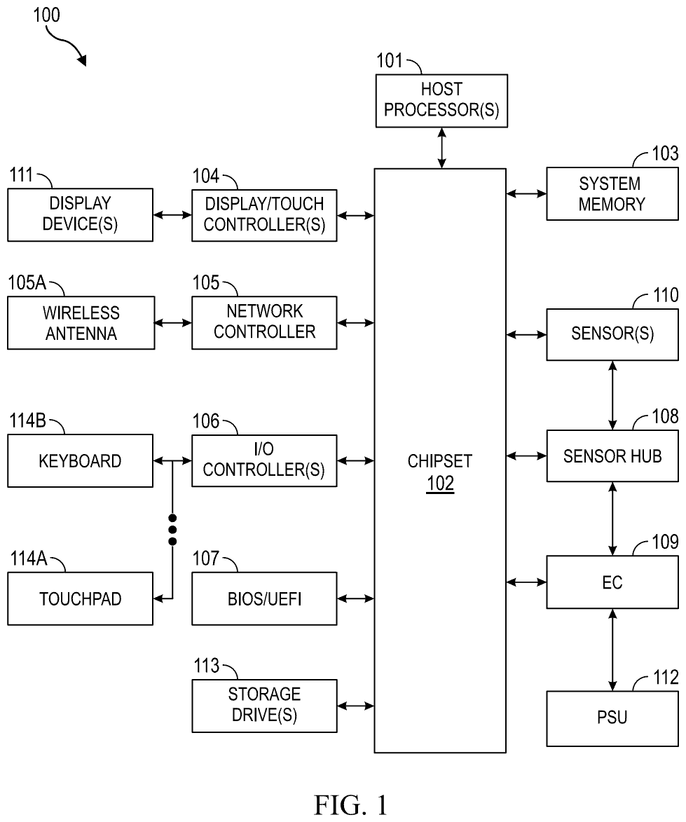

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An example of an IHS is described in more detail with regard to FIG. 1.

FIG. 1 is a diagram illustrating examples of components of an Information Handling System (IHS) configured, according to some embodiments, to support adaptive user presence detection by the IHS through adaptive configuration of wireless signaling by the IHS. In some embodiments, IHS 100 may be a laptop computer with wireless network communication capabilities. In some embodiments, the wireless networking capabilities of IHS 100 may be implemented using multiple antenna, thus providing a source of directional information regarding the wireless signals that are transmitted and received by the IHS 100. As described in additional detail below, in embodiments, IHS 100 may be configured to support adaptive user presence detection using wireless signaling information, where the presence detection capabilities are adapted through selection of profiles used for analysis of the available wireless signaling information in providing different types of user presence detection. Depending on the current operating context of the IHS 100, the selection of different profiles adjusts wireless signaling by the IHS in order to adjust the type of user presence detection to be conducted.

As illustrated, IHS 100 includes host processor(s) 101. In various embodiments, IHS 100 may be a single-processor system, a multi-processor system including two or more processors and/or processor cores. Host processor(s) 101 may include any processor capable of executing program instructions, such as a PENTIUM processor, or any general-purpose or embedded processor implementing any of a variety of Instruction Set Architectures (ISAs), such as an x86 or a Reduced Instruction Set Computer (RISC) ISA (e.g., POWERPC, ARM, SPARC, MIPS, etc.). IHS 100 utilizes a chipset 102 that may include one or more integrated circuits that are connected to processor 101. In the embodiment of FIG. 1, processor 101 is depicted as separate component from chipset 102. In other embodiments, all of chipset 102, or portions of chipset 102 may be implemented directly within the integrated circuitry of the processor 101. Chipset 102 provides the processor(s) 101 with access to a variety of resources of the IHS.

In some embodiments, processor 101 may include an integrated memory controller that may be implemented directly within the circuitry of the processor 101, or the memory controller may be a separate integrated circuit that is located on the same die as the processor 101. The memory controller may be configured to manage the transfer of data to and from the system memory 103 of the IHS 100 via a high-speed memory interface. The system memory 103 provides the processor 101 with a high-speed memory that may be used in the execution of computer program instructions by the processor 101. Accordingly, system memory 103 may include memory components, such as such as static RAM (SRAM), dynamic RAM (DRAM), NAND Flash memory, suitable for supporting high-speed memory operations by the processor 101. In certain embodiments, system memory 103 may combine both persistent, non-volatile memory and volatile memory. In certain embodiments, the system memory 103 may be comprised of multiple removable memory modules.

As illustrated, a variety of resources may be coupled to the processor(s) 101 of the IHS 100 through the chipset 102. For instance, chipset 102 may be coupled to a wireless network controller 105 that may support different types of wireless network connectivity. In certain embodiments, wireless network controller 105 may include one or more Network Interface Controllers (NICs). In some embodiments, wireless network controller 105 may implement hardware for communicating via a specific networking technology, such as Wi-Fi, BLUETOOTH, and mobile cellular networks (e.g., CDMA, TDMA, LTE). In some embodiments, network controller 105 may support wireless Wi-Fi communications, and my include a Wi-Fi controller or wireless NIC card by which IHS 100 transmits and receives wireless Wi-Fi signals.

As indicated in FIG. 1, the wireless signaling utilized by wireless network controller 105 may be implemented using multiple wireless antenna 105a. In transmitting and receiving wireless signals using multiple antenna 105a, the strength of signals that are received by each of these antenna 105a may be analyzed to provide directional information regarding the environment in which the wireless signals are propagated. In some embodiments, the directional information that is used in the transmission and reception of wireless signals from each of the antenna 105a may be used to detect the presence of the user of the IHS 100 relative to the position of the IHS itself.

As described in additional detail below, in some embodiments, specific types of user presence detection may be implemented, where the different types may each be implemented through analysis of wireless signal information from each of the multiple antenna 105a. In embodiments, the different types of user presence detection that are supported by wireless network controller 105 may be selected according to the current operating context of the IHS 100, where the context information may be provided by sensor hub 108 and/or embedded controller 109. The directional wireless signal information from each of the multiple antenna 105a may be used to implement different types of user presence detection, such as detecting the presence of the user in proximity to the IHS, detecting the presence of onlookers, detecting the user's hands near the IHS and detecting gestures being made by the user. Accordingly, in embodiments, different wireless signal profiles may be selected for use by wireless network controller 105 in providing one of these different types of user presence detection, where the profile is selected based on the current operating context of the IHS.

Returning to the hardware and software of an IHS according to embodiments, chipset 102 also provides processor 101 with access to one or more storage drives 113. In various embodiments, storage drives 113 may be integral to the IHS, or may be external to the IHS 100. In some embodiments, storage drive(s) 113 may be accessed via a storage controller that may be an integrated component of the storage device. In some embodiments, a storage controller may be a system-on-chip function of processor(s) 101. Storage drive(s) 113 may be implemented using any memory technology allowing IHS 100 to store and retrieve data. For instance, storage drive(s) 113 may be a magnetic hard disk storage drive or a solid-state storage drive. In certain embodiments, storage drive(s) 113 may include a system of storage devices, such as a cloud drive accessible via network interface 105.

As illustrated, IHS 100 also includes a BIOS (Basic Input/Output System) 107 that may be stored in a non-volatile memory accessible by chipset 102. In some embodiments, BIOS 107 may be implemented using a dedicated microcontroller coupled to the motherboard of IHS 100. In some embodiments, BIOS 107 may be implemented as operations of embedded controller 109. Upon powering or restarting IHS 100, processor(s) 101 may utilize BIOS 107 instructions to initialize and test hardware components coupled to the IHS 100. The BIOS 107 instructions may also load an operating system for use by the IHS 100. The BIOS 107 provides an abstraction layer that allows the operating system to interface with certain hardware components of the IHS 100. The Unified Extensible Firmware Interface (UEFI) was designed as a successor to BIOS. As a result, many IHSs utilize UEFI in addition to or instead of a BIOS. As used herein, BIOS is intended to also encompass UEFI.

In various embodiments, one or more display devices 111 may be coupled to IHS 100. Display device(s) 111 may include a plurality of pixels that are arranged in a matrix and are configured to display visual information. Display device(s) 111 may include Liquid Crystal Display (LCD), Light Emitting Diode (LED), organic LED (OLED), or other thin film display technologies. IHS 100 may support an integrated display device, such as a display integrated into a laptop, tablet, 2-in-1 convertible device, or mobile device. In some embodiments, IHS 100 may be a hybrid laptop computer that includes dual integrated displays incorporated in both of the laptop panels. IHS 100 may also support use of one or more external displays, such as external monitors that may be coupled to IHS 100 via various types of couplings. In some embodiments, chipset 102 may provide access to one or more display device(s) 111 via a graphics processor and/or GPU (Graphics Processor Unit). In certain embodiments, a graphics processor may be comprised within a video or graphics card or within an embedded controller installed within IHS 100. In certain embodiments, a graphics processor may be integrated within processor 101, such as a component of a system-on-chip.

In some embodiments, one or more of the display devices 111 may be capable of receiving touch inputs from a user. In some embodiments, these touch inputs received via display devices 111 may be processed by a touch controller 104 that may be separate from other controllers used the display of content. In some embodiments, the touch controller 104 functions may be implemented by a display controller. In some embodiments, touch controller 104 may be an embedded component of an individual display device 111, such that IHS 100 may support multiple distinct touch controllers 104, each processing inputs from a separate display device 111, such as integrated touch controllers 104 processing inputs from separate display panels of a laptop IHS.

Chipset 102 may also provide access to one or more user input devices, in some instances using one or more I/O controller(s) 106 or the like. Examples of user input devices include, but are not limited to a touchpad (such as a touchpad integrated in the palm rest area of a laptop IHS), keyboard 114B and mouse 114C. In some embodiments, a single controller may support multiple of these user input devices, such as a keyboard controller that detects inputs from the keyboard 114B and also detects inputs from a touchpad 114 integrated in the palm rest, and also detects mouse 114C inputs detected by buttons included on or under a palm rest of an laptop IHS 100. In some embodiments, other user input devices supported through the operation of I/O controller(s) 106 may include a stylus, microphone(s) and camera(s) that may each be integrated or external components of an IHS 100.

Some IHS 100 embodiments may utilize an embedded controller 109 that may be a motherboard component of IHS 100 and may include one or more logic units. In certain embodiments, embedded controller 109 may operate from a separate power plane from the main processors 101 of IHS, and thus from the operating system functions of IHS 100. In some embodiments, firmware instructions utilized by embedded controller 109 may be used to operate a secure execution environment that may include operations for providing various core functions of IHS 100, such as power management and management of certain operating modes of IHS.

For instance, embedded controller 109 may implement operations for interfacing with a power supply unit (PSU) 112 in managing power for IHS 100. In certain instances, the operations of embedded controller may determine the power status of IHS 100, such as whether IHS 100 is operating strictly from battery power, whether any charging inputs are being received by power supply unit 112, and/or the appropriate mode for charging the one or more battery cells of the IHS using the available charging inputs. Embedded controller 109 may support routing and use of power inputs received via a USB port and/or via a power port supported by the power supply unit 112. In addition, operations of embedded controller 109 may interoperate with power supply unit 112 in order to provide battery status information, such as the state of charge of the battery.

In some embodiments, embedded controller 109 may also implement operations for detecting certain changes to the physical configuration of IHS 100 and managing the modes corresponding to different physical configurations of IHS 100. For instance, where IHS 100 is a laptop computer or a convertible laptop computer, embedded controller 109 may receive inputs from a lid position sensor that may detect whether the two sides of the laptop have been latched together, such that the IHS is in a closed position. In response to lid position sensor detecting latching of the lid of IHS 100, embedded controller 109 may initiate operations for shutting down IHS 100 or placing IHS in a low-power mode. In this manner, IHS 100 may support the use of various power modes.

In managing the operation of IHS 100 according to its physical posture, embedded controller 109 may identify any number of IHS physical postures, including, but not limited to: laptop, stand, tablet, or book postures. For example, when an integrated display 111 of IHS 100 is open with respect to a horizontal, face-up position of an integrated keyboard, EC 109 may determine IHS 100 to be in a laptop posture. When an integrated display 111 of IHS 100 is open with respect to a horizontal keyboard portion, but the keyboard is facing down (e.g., its keys are against the top surface of a table), EC 109 may determine IHS 100 to be in a kickstand posture. When the back of an integrated display 111 is closed against the back of the keyboard portion of an IHS, EC 109 may determine IHS 100 to be folded in a tablet posture. When IHS 100 has two integrated displays 111 that are open side-by-side (e.g., in a hybrid laptop with displays in both panels), EC 109 may determine an IHS 100 to be in a book posture. When an IHS 100 is determined to be in a book posture, EC 109 may also determine if the display(s) 111 of IHS 100 are arranged in a landscape or portrait orientation, relative to the user.

IHS 100 may include a wide variety of sensors 110 for use in gathering telemetry data that can be used in the management of operations by the IHS. Sensors 110 may be disposed on or within the chassis of IHS 100, or otherwise coupled to IHS 100, and may include, but are not limited to: electric, magnetic, radio, optical (e.g., camera, webcam, etc.), infrared, thermal (e.g., thermistors etc.), force, pressure, acoustic (e.g., microphone), ultrasonic, proximity, position, deformation, bending, direction, movement, velocity, rotation, gyroscope, Inertial Measurement Unit (IMU), and/or acceleration sensor(s). Sensors 110 may include geo-location sensors capable for providing a geographic location for IHS 100, such as a GPS sensor or other location sensors configured to determine the location of IHS 100 based on triangulation and network information. Various sensors, such as optical, infrared and sonar sensors, may be used in the detection of individuals in proximity to the IHS 100 and/or in other forms of user presence detection. However, the use of such sensors for user presence detection may be limited or unavailable in some scenarios in which the IHS operates, such as the IHS operating without use of the camera due to privacy restrictions that are currently in place. Certain line of sight sensors, such as an infrared sensor, may not be available on entry-level IHS. Accordingly, as described in additional detail below, in embodiments, user presence detection may be provided using solely wireless signal information, and thus by network controller 105.

In some embodiments, sensor hub 108 may utilize data from inertial movement sensors, that may include accelerometer, gyroscope, and magnetometer sensors, to determine the current orientation and any movement of IHS 100 (e.g., IHS 100 is motionless on a relatively flat surface, IHS 100 is being moved irregularly and is likely in transport, the hinge of IHS 100 is oriented in a vertical direction). In certain embodiments, the sensor hub 108 may also include capabilities for determining a location and movement of IHS 100 based on triangulation of network signal and based on network information provided by the OS or by a network interface.

In some embodiments, an IHS 100 may not include all of the components shown in FIGURE. 1. In other embodiments, an IHS 100 may include other components in addition to those that are shown in FIG. 1. Furthermore, some components that are represented as separate components in FIG. 1 may instead be integrated with other components. For example, in certain embodiments, all or a portion of the operations executed by the illustrated components may instead be provided by components integrated into processor(s) 101 as systems-on-a-chip.

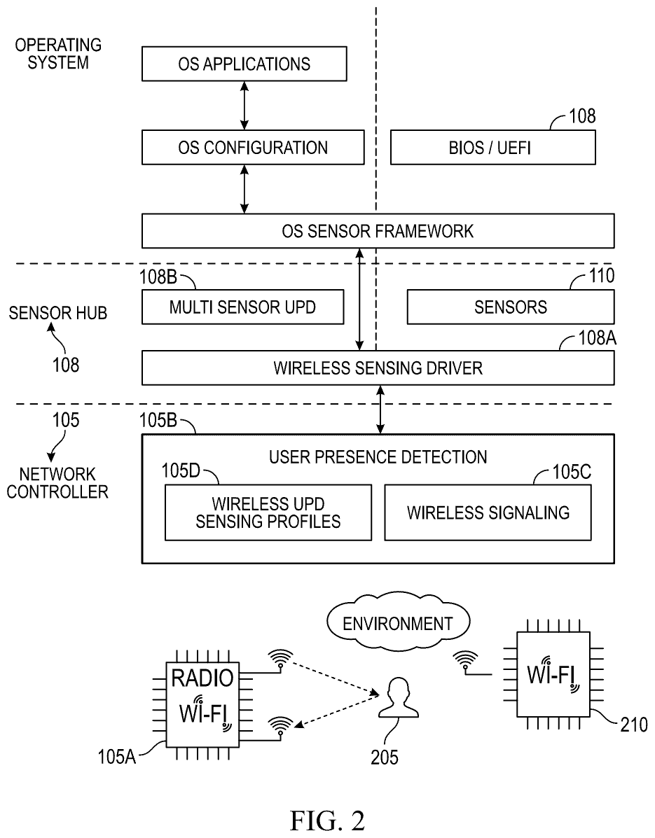

FIG. 2 is a diagram illustrating additional examples of components of an Information Handling System (IHS) configured, according to some embodiments, to support adaptive user presence detection by the IHS through adaptive configuration of wireless signaling by the IHS. As described, in embodiments, IHS 100 may be configured to support adaptive user presence detection using wireless signaling information. In FIG. 2, wireless network controller 105, such as a Wi-Fi controller, supports user presence detection 105b through the use of directional information collected by the multiple antenna 105 utilized by the wireless network controller in wireless signaling 105c.

In some embodiments, wireless network controller 105 may support Wi-Fi communications through wireless signaling 105c that transmits and receives wireless signals using two or more antenna 105a. This wireless signaling 105c by wireless network controller 105 may provide IHS 100 with wireless network communications using the multiple antenna 105a through multipath signaling that MIMO (multiple-input and multiple-output) wireless transmissions. Through such MIMO wireless transmissions from each of the antenna 105a, directional information may be calculated based on the different signal properties detected by the different antenna. Using OFDMA (Orthogonal Frequency-Division Multiple Access), multiple transmission channels are transmitted simultaneously in wireless communications, such as some standardized Wi-Fi versions. In optimizing the use of available transmission channels within the constraints of the physical environment in which the wireless signals are being propagated, participants may generate CSI (channel state information) for use in separately optimizing the capacity of each of the channels.

In some embodiments, changes in channel state information collected by each of the antenna 105a may be analyzed to identify the location of other wireless transceivers 210 and to locate obstacles, such as the user 205, within the propagation environment. Through the analysis of such wireless channel information collected by each of the antenna 105a, the user presence detection 105b function of wireless network controller 105 may locate the user relative to the IHS 100. As described in additional detail below, embodiments may support different types of user presence detection, where support for the supported types of presence detection capabilities are adapted through selection of profiles 105d that are used by the wireless network controller 105 in the analysis of the available wireless signaling information in providing different types of user presence detection.

Depending on the current operating context of the IHS 100, the selection of different profiles 105d adjusts wireless signaling by the IHS in order to adjust the type of user presence detection to be conducted. In some embodiments, the different profiles 105d may adjust the transmission and reception parameters used in wireless signaling 105c by the network controller 105. For instance, different profiles 105d may configure the use of different reception sensitivities used by some or all of the antenna 105a in order to collect different channel state information describing different areas relative to the IHs, such as to adjust sensitivities to detect obstacles very near to the IHS, such as detecting the user's 205 hands near the keyboard of a laptop IHS, or such as to adjust transmission power to detect the general presence of a user 205 in the same room as the IHS.

As described above, an IHS may include a sensor hub 108 that may interface with one or more sensors 110 and other sources of information (e.g., cameras, infrared sensors, time-of-flight sensors, microphones, etc.) in performing various evaluations of the IHS operating state. In some instance, a sensor hub 108 may synthesize telemetry collected from multiple sensors 110 in supporting multi-sensor user presence detection 108b. In some instances, the data collected and analyzed in multi-sensor user presence detection 108b by the sensor hub 108 may include wireless signaling data collected by a wireless sensing driver 108a of the sensor hub. However, as described, in some IHSs such as entry-level IHSs, such complex sensor hub implementations of user presence detection are not available. In some instances, an IHS may include a sensor hub 108 that is capable of multi-sensor user presence detection 108b, but such capabilities are not available, such as due to privacy restrictions, power limitations, etc. Accordingly, in embodiments, user presence detection is provided solely using wireless signaling 105c data collected by network controller 105.

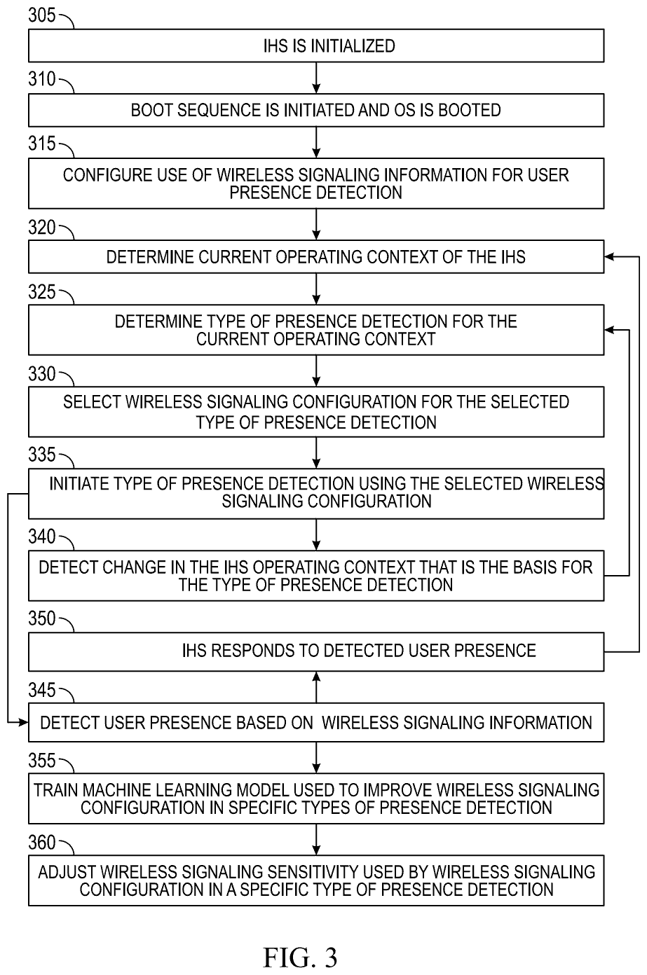

FIG. 3 is a flowchart illustrating an example of a method, according to some embodiments, for adaptive user presence detection by an IHS through adaptive configuration of wireless signaling by the IHS. Embodiments may begin, at 305, with the initialization of an IHS 100, such as upon booting or restarting the IHS. In some embodiments, upon initialization of an IHS, instructions to be loaded for use by hardware components of the IHS, such as firmware and other settings, may be validated as authentic based on comparisons of the instructions to be loaded against reference signatures corresponding to authentic instructions. Upon successful validation of such instructions, one or more of the hardware components of the IHS 100 may load validated instructions and may thus operate based on execution of these trusted instructions. In embodiments, this validated firmware to be loaded by components of the IHS 100 may include firmware for use in providing user presence detection capabilities that are implemented based on wireless signal information from multiple antenna 105a and in selecting different profiles for using wireless signal information in providing different types of user presence detection depending on the current operating context of the IHS 100.

Once firmware instructions for use in embodiments have been validated, at 310, further initialization may include initiating the IHS 100 boot sequence and loading operating system instructions. Once a requisite amount of instructions have been loaded and the IHS is in operation, at 315, embodiments may configure and initiate use of wireless signaling information for user presence detection. As described above, in embodiments, an IHS 100 includes two or more antenna used to transmit and receive wireless signals, such as Wi-Fi communications. In such wireless signaling that utilized multiple antenna, directional signal information may be used to detect the presence of the user relative to the IHS. Wireless communications such as Wi-Fi may be transmitted using multiple channels of data being transmitted simultaneously, where different channels may be transmitted orthogonal to each other, and thus affected differently by obstructions in the environment in which the signals are propagated.

In transmitting and receiving wireless signals using multiple antenna, the differing magnitudes of signal properties measured by the different antenna provides further directional information. As described above, the channel-specific signal information measured and used by each of the multiple antenna 105a may be used in the detection of individuals in proximity to the IHS, including determining the location of an individual relative to the IHS. In some embodiments, such user presence detection based on wireless signal information may be initiated as a background process of the IHS.

As described above, different types of presence detection may be supported by embodiments through evaluation of wireless signal data, such as detecting the user being near the IHS, detecting the user's hands near the IHS and detecting specific gestures made by the user. Each of these different types of user presence detection may be used in different contexts of the IHS's operations. Accordingly, at 320, embodiments may determine the current operating context of the IHS for use in selecting the appropriate type of user presence detection to be provided. Embodiments may collect and utilize a variety of context information that may then be used in determining a specific type of user presence detection to be conducted using wireless signaling data.

In some embodiments, the IHS context may include ambient light measurements that are made using sensors 110 of the IHS. In an IHS such as a laptop computer with an integrated keyboard, some or all of the keys may include backlighting or other illumination that supports use of the IHS in low light environments. However, in most instances, once the keyboard has been illuminated, the keyboard lighting is turned off when no keypress is detected for a predefined interval, such that the illumination times out and power is conserved. In dark environments, a user must typically press a key in order to re-illuminate the keyboard. Such operations by the user can result in unintentional inputs to the IHS, such as closing an application, pausing on ongoing multimedia feed and/or deleting information. Accordingly, embodiments may utilize ambient light measurements to select a type of user presence detection that can be used to initiate keyboard lighting once the user's hands are detected in proximity to the IHS, and in particular in proximity to the keyboard of the IHS.

In some embodiments, the IHS context may include the application(s) that are operating on the IHS, and in some instances any specific modes or states of these applications. For instance, in a scenario where an IHS is running an application that is currently in a presentation mode, and/or the IHS is coupled to an external projector, embodiments may select a type of user presence detection that can be used to detect specific gestures by the user. In response to detecting hand and/or arm gestures, the user is able to advance slides or pages within a presentation using only gestures and thus without the user having to break focus from the presentation.

In some embodiments, the IHS context may include the power mode or other power information of the IHS. For portable IHSs that operate using rechargeable batteries, context information may include: the state of charge of these batteries, whether the IHS is currently drawing power from the batteries, whether the IHS is currently coupled to an external power source and/or the current power mode of the IHS (e.g., sleep, hibernate, standby). In scenarios where the IHS 100 is in a low power mode, embodiments may select a type of user presence detection that can used to detect the user in the general proximity of the IHS (e.g., in the same room as the IHS), thus allowing the IHS to preemptively transition to a ready power mode in anticipation of the user approaching the IHS.

In some embodiments, the IHS context may include the location of the IHS. In a private location, such as a home or office setting, privacy protections supported by an IHS 100 may not be enabled. For instance, an IHS 100 may support privacy measures such as screen blurring that are intended to prevent onlookers from viewing protected information that is being displayed. In scenarios where such onlooker mitigation procedures are being utilized, such as due to the IHS being used in a public or otherwise unknown location, embodiments may select a type of user presence detection that can used to detect the presence of multiple individuals in close proximity to the IHS.

In some embodiments, the IHS context may include the presence of multiple wireless signal transceivers 210, such as other IHSs, that are detected in the physical environment in which the user presence detection is being conducted. As described in additional detail below, user presence detection may be aided and improved when utilizing wireless signal information that is collected by different participating devices 210 that are located in the physical environment where the user 205 is located. Based on such context describing the specific wireless environment in which the IHS is operating, embodiments may select a wireless signaling configuration that is adapted to utilize the wireless signal information that can be provided by the different participating devices in the wireless environment, such as in support of detecting onlookers in the proximity to the IHS.

In some embodiments, context information indicating the presence of other participating transceivers 210 in the environment may result in the selection of a wireless signaling profile 105d that incorporates information provided by these other transceivers 210 in user presence detection. For instance, the detection of a transceivers 210 that can provide channel information describing directional information may result in the selection of a profile 105d that requests channel state information from a remote transceivers 210, thus providing additional directional information describing obstructions in the environment. Through use of this additional directional information, a wireless signal profile may be selected by embodiments that support detection of multiple individuals in proximity to the IHS, thus supporting capabilities such as onlooker detection. In environments where multiple different transceivers 210 are present, a wireless signaling profile may be selected that leverages the availability of multiple sources of directional information to configure wireless signaling 105c in a manner that sequences communications with each individual transceivers 210 in a manner that generates spatial information that is targeted as specific areas relative to the IHS.

In this manner, embodiments may collect a variety of status information and telemetry describing the current operating context of the IHS. Once this context information has been collected, at 325, embodiments may determine a type of presence detection to be provided based on the current operating context. In the scenario described above, the ambient light context information may result in the selection of a type of user presence detection that detects the user's hands in proximity to the keyboard of the IHS. In the above-described scenario where the IHS context is a low power state, the selected type of user presence detection may be used to identify the location of the user relative to the IHS, such as measuring the distance between the user and the IHS in order to locate the user in the same room as the IHS and to anticipate the user moving towards the IHS in order to operate it. In the scenario described above where the IHS context includes a presentation-mode application being operated by the user, the selected type of user presence detection may be used to identify gestures made by the user. In the described scenario where the IHS context includes a public or otherwise untrusted location, the selected type of user presence detection may be utilize wireless signaling that is adapted to identify onlookers in proximity to the IHS.

Once the type of user presence detection has been selected, at 330, embodiments may select a wireless signaling profile 105d to be used in providing the selected type of presence detection. As described, embodiments may identify the user relative to the IHS based on analysis of directional information calculated from data collected in the multi-channel transmission of wireless signal data by two or more antenna 105a. In embodiments, the wireless signaling 105c by the IHS may be further adjusted through use of each profile 105d in order to identify the user in a particular manner. For instance, adjusting the sensitivity of one or more of the antenna of the IHS may be used in embodiments to tune the amount of data that is collected and available for detecting the presence of a user and/or identifying specific aspects of a user, such as gestures being made by the user. Different wireless signaling profiles 105d may additionally or alternatively adjust the transmission power used in wireless signaling in order to tune the distances at which the user can best be detected from the IHS using the signal information being collected by the antenna. As such, different wireless signaling profiles 105d may specify different antenna sensitivity and power configurations and other antenna settings to be used in providing a specific type of user presence detection, while still supporting wireless network communications by the IHS.

With the wireless signaling profile 105d selected based on the current IHS operating context, at 335, the IHS initiates a specific type of presence detection using the selected wireless signaling configuration. In some embodiments, the wireless signaling profile 105d may specify transmission and reception settings such as sensitivity and power that may be used to generate wireless signal information in the physical area relative to the IHS in which the user's presence is to be monitored. Using the wireless signaling profile 105d, embodiments may collect and evaluate wireless signaling data in order to locate the user relative to the IHS.

However, in some instances, at 340, the context in which the IHS operates may change prior to the user's presence being detected using the selected signaling profile 105d. For instance, in the scenario where the IHS context includes ambient lighting sensors indicating the IHS being operated in a low light environment, that context may change due to a change in ambient lighting. Through this change in context, the need is obviated for user presence detection to monitor for the user's hands in proximity to the keyboard in order to trigger keyboard backlighting. Similarly, movement of an IHS from an unknown location to a trusted location may obviate the need for use of user presence detection to monitor for onlookers. In this same manner, a change in context that includes the user exiting a presentation mode of an active application obviates further monitoring for gestures through the use of wireless signaling presence detection. Accordingly, as indicated in FIG. 3, embodiments may return, at 325, to the selection of an appropriate type of user presence detection to be provided in the new operating context of the IHS. For instance, in a scenario where the context changes from the IHS transitioning to a full power mode of operations, the need is obviated for user presence detection to identify the user in proximity to the IHS in order to trigger wake operation. In the new context, low ambient light conditions may result in a switch to user presence detection for detecting the user's hands proximity to the IHS.

In some scenarios, at 345, the configured type of user presence detection is used in successfully detecting the location of the user relative to the IHS, gestures made by the user, the presence of onlookers and/or the position of the user's hands relative to the IHS. At 350, the IHS responds to the detected presence of the user. As described, in the scenario where the user's hands are detected in proximity to the IHS keyboard in a low ambient light context, the IHS responds by illuminating one or more of the keys of the keyboard. In the scenario where the user is detect in proximity to the IHS while the IHS is in a low power context, the IHS responds by waking the IHS, either fully or partially, in anticipation of the IHS resuming operation of the IHS. In the scenario where the user's hand and/or arm gestures are detected while the IHS is in a presentation mode context, the IHS responds to the detected gestures, such as by advancing the presentation to the next page. In the scenario where an onlooker is detected in proximity to the IHS while the IHS is in an untrusted physical environment context, the IHS responds by initiating onlooker mitigation procedures such as screen blurring.

Once the IHS responds to the detection of the user, as indicated in FIG. 3, embodiments may continue, at 320, by determining the current operating context of the IHS in order to select a type of user presence detection that is appropriate. Also as indicated in FIG. 3, in addition to trigging a response by the IHS, at 355, the detection of the user may also trigger training of a machine learning model that is used to adjust the parameters of each of the wireless signaling profiles 105d that are supported. For instance, when configured for detection of user gestures, the detection of a specific gesture and resulting response may be used as feedback training of a machine learning model such as a neural network, where the feedback confirms that the detected user movements did correspond to that specific gesture, thus improving the confidence of the neural network in future gesture determinations made based on similar data.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks.

Program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices.

Similarly, operational data may be identified and illustrated herein within modules and may be embodied in any suitable form and organized within any suitable type of data structure. Operational data may be collected as a single data set or may be distributed over different locations including over different storage devices.

Reference is made herein to “configuring” a device or a device “configured to” perform some operation(s). This may include selecting predefined logic blocks and logically associating them. It may also include programming computer software-based logic of a retrofit control device, wiring discrete hardware components, or a combination of thereof. Such configured devices are physically designed to perform the specified operation(s).

Various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs.

As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. A method for adaptive user presence detection by a first Information Handling System (IHS), the method comprising:
transmitting and receiving wireless communications with a second IHS using a wireless network controller of the first IHS;
determining a context in which the first IHS transmits and receives the wireless communications with the second IHS;
based on the context of the wireless communications, selecting a wireless signaling profile for use by the wireless network controller in the wireless communications with the second IHS, wherein the selected wireless signaling profile adapts the transmission and reception of the wireless communications with the second IHS in supporting different types of user presence detection by the first IHS; and
using the wireless communications that have been adapted according to the wireless signaling profile to locate a user of the first IHS relative to the first IHS.

2. The method of claim 1, wherein the first IHS comprises at least two antennas for the transmission and reception of the wireless communications, and wherein the selected wireless signaling profile adapts the transmission and reception by the antennas in order to support a specific type of user presence detection.

3. The method of claim 2, wherein the specific type of user presence detection comprises detecting whether the user is located within a proximity to the first IHS.

4. The method of claim 3, wherein the context in which the first IHS transmits and receives the wireless communications with the second IHS comprises a low power mode of the IHS.

5. The method of claim 4, further comprising waking the first IHS from the low power mode in response to locating the user of the first IHS within the proximity to the IHS using the wireless signaling profile.

6. The method of claim 2, wherein the specific type of user presence detection comprises detecting gestures made by the user.

7. The method of claim 6, wherein the context in which the first IHS transmits and receives the wireless communications with the second IHS comprises an application of the first IHS operating in a presentation mode.

8. The method of claim 7, further comprising conducting an operation of the presentation mode in response to detecting a gesture made by the user through use of the wireless signaling profile.

9. The method of claim 2, wherein the specific type of user presence detection comprises detecting whether the user's hands are located in proximity to the first IHS.

10. The method of claim 9, wherein the context in which the first IHS transmits and receives the wireless communications with the second IHS comprises a level of ambient light detected by the first IHS.

11. The method of claim 10, further comprising illuminating lighting of the first IHS in response to detecting the user's hands in proximity to the first IHS.

12. The method of claim 1, wherein the wireless network controller of the first IHS uses the selected wireless signaling profile to adapt the transmission and reception of the wireless communications with the second IHS in supporting different types of user presence detection by the first IHS.

13. The method of claim 1, wherein the selected wireless signaling profile adapts the transmission and reception of the wireless communications with the second IHS by utilizing directional wireless signaling information provided by the second IHS.

14. The method of claim 2, wherein the selected wireless signaling profile adapts the transmission and reception of the wireless communications with the second IHS by modifying directional wireless signaling information generated by the two or antennas in the transmission and reception of wireless communications with the second IHS.

15. The method of claim 2, wherein the selected wireless signaling profile adapts the transmission and reception by the two or more antennas in order to support a specific type of user presence detection by modifying sensitivity settings used by the antennas in the reception of wireless communications from the second IHS.

16. A first Information Handling System (IHS) comprising:
a wireless network controller;
one or more processors; and
one or more memory devices coupled to the one or more processors, the memory devices storing computer-readable instructions that, upon execution by the one or more processors, cause the first IHS to:
transmit and receive wireless communications with a second IHS through operation of the wireless network controller;
determine a context in which the first IHS transmits and receives the wireless communications with the second IHS;
based on the context of the wireless communications, select a wireless signaling profile for use by the wireless network controller in the wireless communications with the second IHS, wherein the selected wireless signaling profile adapts the transmission and reception of the wireless communications with the second IHS in supporting different types of user presence detection by the first IHS; and
use the wireless communications that have been adapted according to the wireless signaling profile to locate a user of the first IHS relative to the first IHS.

17. The first IHS of claim 16, further comprising at least two antennas for the transmission and reception of the wireless communications, wherein the selected wireless signaling profile adapts the transmission and reception by the antennas in order to support a specific type of user presence detection.

18. The first IHS of claim 16, wherein the wireless network controller uses the selected wireless signaling profile to adapt the transmission and reception of the wireless communications with the second IHS in supporting different types of user presence detection by the first IHS.

19. A computer-readable storage device having instructions stored thereon for adaptive user presence detection by a first IHS (Information Handling System), wherein execution of the instructions by one or more processors of the first IHS causes the one or more processors to:
transmit and receive wireless communications with a second IHS through operation of a wireless network controller of the first IHS;
determine a context in which the first IHS transmits and receives the wireless communications with the second IHS;
based on the context of the wireless communications, select a wireless signaling profile for use by the wireless network controller in the wireless communications with the second IHS, wherein the selected wireless signaling profile adapts the transmission and reception of the wireless communications with the second IHS in supporting different types of user presence detection by the first IHS; and
use the wireless communications that have been adapted according to the wireless signaling profile to locate a user of the first IHS relative to the first IHS.

20. The computer-readable storage device of claim 19, further comprising at least two antennas for the transmission and reception of the wireless communications, wherein the selected wireless signaling profile adapts the transmission and reception by the antennas in order to support a specific type of user presence detection.
